(19) United States
(12) Patent Application Publication
(10) Pub. No.: US 2026/0109017 A1
(43) Pub. Date: Apr. 23, 2026

(54) Rolling Modular Storage System Unit

(71) Applicant: Milwaukee Electric Tool Corporation, Brookfield, WI (US)

(72) Inventors: Charlie G. Noble, New Berlin, WI (US); David R. Hillenbrand, Grafton, WI (US)

(21) Appl. No.: 19/324,647

(22) Filed: Sep. 10, 2025

Related U.S. Application Data
(60) Provisional application No. 63/710,136, filed on Oct. 22, 2024.
(60) Provisional application No. 63/728,840, filed on Dec. 6, 2024.

(51) Int. Cl. B25H 3/02

(52) U.S. Cl. CPC B25H 3/027

(57) ABSTRACT

Various embodiments of a rolling modular storage unit and various features and devices for modular storage units are provided. In various embodiments the rolling modular storage unit includes a main body with a front surface, a rear surface, and side surfaces extending between and connecting the front surface and the rear surface. In various embodiments, an upper surface includes one or more female couplers. In specific embodiments, the rolling modular storage unit includes a lid having two separately openable lid sections. In specific embodiments, an array of female components are positioned on the lid.

### CROSS-REFERENCE TO RELATED PATENT APPLICATIONS

The present application claims priority to and the benefit of U.S. Provisional Application No. 63/728,840, filed on Dec. 6, 2024, and to U.S. Provisional Application No. 63/710,136 filed on Oct. 22, 2024, which re incorporated herein by reference in their entireties.

### BACKGROUND OF THE INVENTION

The present disclosure is directed generally to the field of modular storage devices and systems. The present disclosure relates specifically to a rolling modular storage unit and to various features and devices for modular storage units.

### SUMMARY OF THE INVENTION

One embodiment of the invention relates to a mobile utility module having a main body and a lid. The main body includes a front surface, a rear surface opposing the front surface, a pair of side surfaces, each of the pair of side surfaces extends along a major axis of the main body and connects the front surface and the rear surface. The mobile utility module further includes a pair of wheels and an extendable handle. Each one of the pair of wheels is positioned along a respective one of the pair of side surfaces. The extendable handle extends from the front surface. The lid includes a first portion pivotably coupled to the main body and a second portion pivotably coupled to the main body. The first portion includes a first upper surface and a first plurality of female couplers positioned on the first upper surface and arranged in a small array. The second portion includes a second upper surface and a second plurality of female couplers positioned on the second upper surface and arranged in a large array. A number of the second plurality of female couplers is 2 times a number of the first plurality of female couplers. The first portion of the lid is independently pivotable from the second portion of the lid. The first portion of the lid is positioned between the second portion of the lid and the extendable handle.

Another embodiment of the invention relates to a mobile utility module having a main body and a lid. The main body includes a front surface, a rear surface opposing the front surface, a pair of side surfaces, each of the pair of side surfaces extends along a major axis of the main body and connects the front surface and the rear surface. The mobile utility module further includes a pair of wheels. Each one of the pair of wheels is positioned along a respective one of the pair of side surfaces. The lid includes a first portion pivotably coupled to the main body and a second portion pivotably coupled to the main body. The first portion includes a first upper surface and a first plurality of female couplers positioned on the first upper surface. The second portion includes a second upper surface and a second plurality of female couplers positioned on the second upper surface. The lid further includes a recessed section positioned on one of the first portion of the lid and the second portion of the lid, the recessed section positioned between the first plurality of female couplers and the second plurality of female couplers. The recessed section is offset from a central minor axis of the main body. The first portion of the lid is independently pivotable from the second portion of the lid. The first portion of the lid is positioned between the second portion of the lid and the front surface of the main body.

Another embodiment of the invention relates to a mobile utility module having a main body and a lid. The main body includes a front surface, a rear surface opposing the front surface, a pair of side surfaces, each of the pair of side surfaces extends between and connects the front surface and the rear surface. The mobile utility module further includes a first wheel and a second wheel connected to the first wheel by an axle. The first wheel and the second wheel are positioned along a respective one of the pair of side surfaces. The lid includes a first portion pivotably coupled to the main body and a second portion pivotably coupled to the main body. The first portion includes a first upper surface and a first plurality of female couplers positioned on the first upper surface. The second portion includes a second upper surface and a second plurality of female couplers positioned on the second upper surface. The lid further includes a recessed section extending between a first edge of the lid and an opposing second edge of the lid. The recessed section is positioned on one of the first portion of the lid and the second portion of the lid between the first plurality of female couplers and the second plurality of female couplers. The first plurality of female couplers and the second plurality of female couplers are configured to slidably engage a plurality of male couplers of a utility module. A sliding engagement direction is parallel to an orientation of the axle.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a rolling modular storage unit, according to an exemplary embodiment.

FIG. 2 is a detailed perspective view of a female coupler, according to an exemplary embodiment.

FIG. 3 is perspective view of a male coupler, according to an exemplary embodiment.

FIG. 4 is a right side perspective view of the male coupler of FIG. 3, according to an exemplary embodiment.

FIG. 5 is a rolling modular storage unit, according to another exemplary embodiment.

FIG. 6 is a rolling modular storage unit, according to another exemplary embodiment.

FIG. 7 is a rolling modular storage unit with an open lid, according to another exemplary embodiment.

FIG. 8 is a rolling modular storage unit, according to another exemplary embodiment.

FIG. 9 is a rolling modular storage unit, according to another exemplary embodiment.

FIG. 10 is a top view of the rolling modular storage unit of FIG. 9, according to an exemplary embodiment.

FIG. 11 is a left side view of the rolling modular storage unit of FIG. 9, according to an exemplary embodiment.

FIG. 12 is a top view a rolling modular storage unit with an open lid, according to an exemplary embodiment.

FIG. 13 is a cross-sectional view of the rolling modular storage unit of FIG. 12, according to an exemplary embodiment.

FIG. 14 is a top view of rolling modular storage unit with storage cavity dividers, according to an exemplary embodiment.

FIG. 15 is top view of the rolling modular storage unit of FIG. 14 with storage cavity trays, according to an exemplary embodiment.

FIG. 16 is a detailed top view of a rolling modular storage unit, according to an exemplary embodiment.

FIG. 17 is modular storage system including the rolling modular storage unit of FIG. 16, according to an exemplary embodiment.

FIG. 18 is a detailed view of the spacing of the modular storage system of FIG. 17, according to an exemplary embodiment.

FIG. 19 is a detailed view of the spacing of the modular storage system of FIG. 17, according to an exemplary embodiment.

FIG. 20 is a detailed view of the positioning of storage units of the modular storage system of FIG. 17, according to an exemplary embodiment.

FIG. 21 is a perspective view of a rolling modular storage unit on stairs, according to an exemplary embodiment.

FIG. 22 is a detailed view of the rolling modular storage unit of FIG. 21, according to an exemplary embodiment.

FIG. 23 is a right side view of a rolling modular storage unit with a retracted handle, according to an exemplary embodiment.

FIG. 24 is a right side view of the rolling modular storage unit of FIG. 23 with an extended handle, according to an exemplary embodiment.

FIG. 25 is a top view of a handle locking mechanism, according to an exemplary embodiment.

FIG. 26 is a perspective view of the handle locking mechanism of FIG. 25, according to an exemplary embodiment.

FIG. 27 is a plurality of rolling modular storage units with handles, according to exemplary embodiments.

FIG. 28 is a detailed view of a rear portion of a rolling modular storage unit, according to an exemplary embodiment.

FIG. 29 is a rear perspective view of the rolling modular storage unit of FIG. 28, according to an exemplary embodiment.

FIG. 30 is a detailed view of a rear portion of a rolling modular storage unit in an upright position, according to an exemplary embodiment.

FIG. 31 is a perspective view of rolling modular storage unit with lid storage, according to an exemplary embodiment.

FIG. 32 is a detailed view of the lid storage of the rolling modular storage unit of FIG. 31, according to an exemplary embodiment.

FIG. 33 is a perspective view of a rolling modular storage unit with a lid prop, according to an exemplary embodiment.

FIG. 34 is a perspective view of a rolling modular storage unit with a lid prop, according to another exemplary embodiment.

FIG. 35 is a left side view of a rolling modular storage unit, according to an exemplary embodiment.

FIG. 36 is a detailed view of padlock locations on a rolling modular storage unit, according to an exemplary embodiment.

FIG. 37 is a detailed view of a storage cavity of a rolling modular storage unit, according to an exemplary embodiment.

FIG. 38 is a perspective view of a rolling modular storage unit, according to an exemplary embodiment.

FIG. 39 is a detailed view of the front of the rolling modular storage unit of FIG. 28, according to an exemplary embodiment.

FIG. 40 is a right side view of a rolling modular storage unit in a push and/or pull position, according to an exemplary embodiment.

### DETAILED DESCRIPTION

Referring generally to the figures, various embodiments of rolling modular storage units that can be utilized with a modular storage system are provided. In various embodiments, the rolling modular storage unit is compact in size and/or includes various features that provide for improved storage, portability, durability and/or access to container compartments. In specific embodiments, the rolling modular storage unit includes coupling mechanism(s) (e.g., male and/or female coupling component(s)) configured to engage with units of a modular storage system, such as a modular or stackable tool storage system, a modular worksite storage system, a modular transit storage system, etc.

In various embodiments, the rolling modular storage unit includes a split lid having a pivoting first section and a second section that are separately openable. As will be generally understood, the split lid sections allow access to the storage cavity of the rolling modular storage unit even when other modular storage systems are stacked on the other section of the lid. In a specific embodiment, the split lid allows the smaller front lid portion to open while other storage units remain stacked and coupled to the female coupling components of the larger lid portion. In various embodiments, one of the first and second section of the lid includes a space between the female coupling components such that positioning and/or locking another storage unit to the split lid in a position the prevents opening the first or second section of the lid is prevented.

In various embodiments, the female coupling components define a sliding direction in which additional units will slide to engage the array of female coupling components. In specific embodiments, this sliding direction is perpendicular to the side surface of the rolling modular storage unit. In specific embodiments this sliding direction is parallel to the axle of the wheels of the rolling modular storage unit. In a specific embodiment, the rolling modular storage unit includes a large array of female coupling components at the end of the lid adjacent to the wheels, and a small array of female coupling components at the end of the lid closer to the handle. In a specific embodiment, the rolling modular storage unit includes a handle locking mechanism to lock the handle in the extended position.

In specific embodiments, the rolling modular storage unit discussed herein include one or more female couplers and/or one or more male couplers located on a surface of the unit and that are configured to engage one or more corresponding mating couplers of an adjacent modular unit (e.g., a modular tool storage container, a modular utility module, a modular support component, etc.) In various embodiments, the male and female couplers described herein and shown in the figures are compatible with the coupling mechanism(s) described in International Patent International Patent Publication No. WO 2017/191628, which is hereby incorporated by reference in its entirety. In various embodiments, the female couplers and male couplers described herein engage with each other to rigidly couple together various components including such coupling structures.

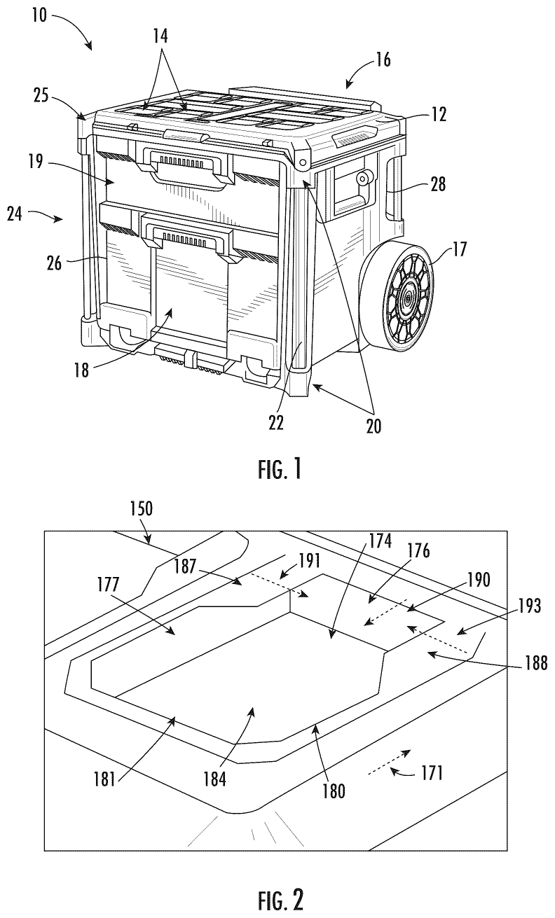

Referring to FIG. 1, details of a rolling storage unit or module 10 are shown according to an exemplary embodiment. Rolling storage module 10 includes a lid 25 with an upper surface 12 and an opposing lower surface facing away from the upper surface 12. One or more female couplers 14 extend from and/or are located in upper surface 12 of rolling storage module 10. The one or more female couplers 14 are configured to engage one or more male couplers (see e.g., male coupler 172 in FIG. 4) that extend from a surface such as a lower and/or rear surface of another utility module.

Rolling storage module 10 includes a main body 24 with a plurality of corners 20. In various embodiments, corners 20 define outermost edges of rolling storage module 10. In various specific embodiments, corners 20 are reinforced with a material such as metal. Rolling storage module 10 further includes a plurality of corner posts or pillars 22 extending between and connecting opposing upper and lower corners 20. In various specific embodiments, corner posts 22 are formed from aluminum and are aluminum extrusion posts.

Main body 24 includes a front wall 26 and an opposing rear wall 28. A handle 16 is coupled to main body 24 along rear wall 28. In various embodiments, a first rolling drawer 18 is positioned within main body 24. In various specific embodiments, a second drawer 19 is positioned within main body. In specific embodiments, the first drawer 18 has a first depth and second drawer 19 has a second depth. In various embodiments, the first depth is different than the second depth. In specific embodiments, the first depth is greater than the second depth. As will generally be understood, the rolling storage modules discussed herein with drawer(s) 18, 19 that include wheel(s) allows for the opening of the drawer and access to stored items without unstacking any units or boxes engaged or stacked on the upper surface 12 of rolling storage module 10. Rolling storage module 10 further includes wheels 17. Wheels 17 are coupled to main body 24 adjacent to rear wall 28.

Referring to FIGS. 2-4, various details of male and female couplers that allow for engagement between a rolling storage unit and various other utility modules or storage devices are shown. Various aspects of a female coupler 150 are shown. Female coupler 150 is substantially the same as female couplers 14 and can be utilized with rolling storage modules. In various embodiments female couplers 14 are structurally and functionally the same or similar to female coupler 150.

Female coupler 150 includes a recessed surface 174 below a top or uppermost surface. Back wall 176, opposing front wall 181, first sidewall 178, and opposing second sidewall 180 extend upward from recessed surface 174. Female coupler 150 includes a pocket 184 collectively defined by recessed surface 174, back wall 176, front wall 181, first sidewall 178, and second sidewall 180.

First rib 187 extends from back wall 176 and first sidewall 177 above pocket 184 and/or recessed surface 174. In particular, first rib 187 extends in direction 191 from first sidewall 177 and first rib 187 extends in direction 190 from back wall 176. Second rib 188 extends from back wall 176 and second sidewall 180 above pocket 184 and/or recessed surface 174. In particular, second rib 188 extends in direction 193 from second sidewall 180 and second rib 188 extends in direction 190 from back wall 176. To couple female coupler 150 to a male coupler, such as male coupler 172, the male coupler 172 moves in direction 171 with respect to the female coupler 150.

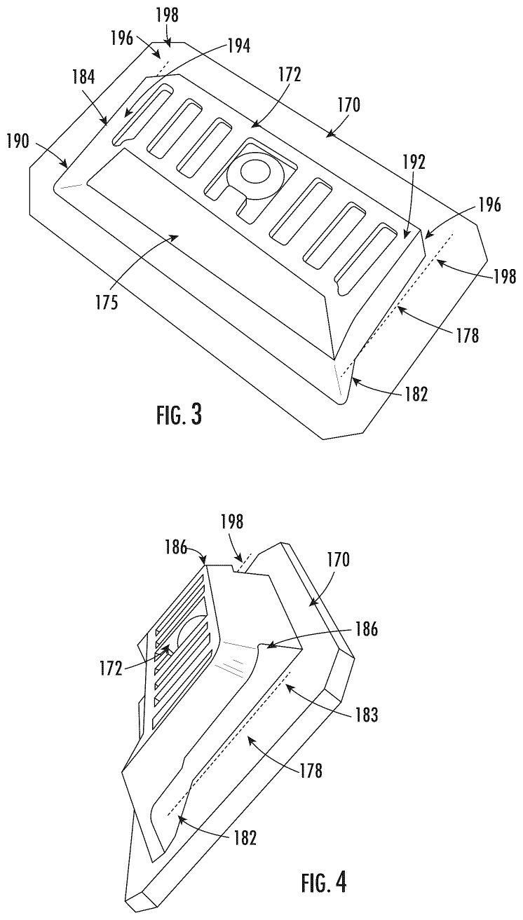

Referring to FIGS. 3-4, in various embodiments, the utility module and/or storage device includes a male coupler 172 extending from a surface, such as surface 170 of the utility module and/or storage device (e.g., 10.). Male coupler 172 includes a body 175 extending from the surface, a first tongue 186, and a second tongue 186. The first tongue 186 and the second tongue 186 both extend from the body 175 and both are offset from and above the surface. The first tongue 186 defines a first channel 198 between the back surface and the first tongue 186, and the second tongue 186 defines a second channel 198 between the back surface and the second tongue 186. The first channel 198 and second channel 198 each extend on opposing sides (e.g., first side 192 and opposing second side 194) of the body 175.

Each of first channel 198 and second channel 198 includes a front open end and a back closed end. For example, first channel 198 includes a front open end 183 and a back closed end 182, and second channel 198 includes a front open end 183 and a back closed end 182.

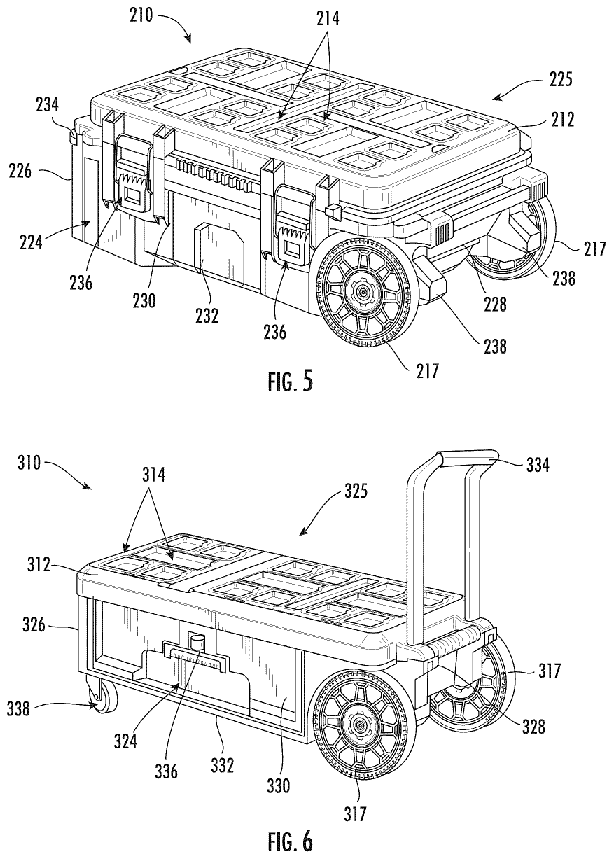

Referring to FIG. 5, details of a rolling utility module 210 are shown according to an exemplary embodiment. Rolling utility module 210 is substantially the same as rolling utility module 10 except for the differences discussed herein. Rolling utility module 210 includes a main body 224 and a lid 225. Main body 224 and lid 225 together define an internal cavity or storage compartment. One or more female couplers 214 are defined in an upper surface 212 of lid 225. Main body 224 includes a front surface 226, an opposing rear surface 228 and a pair of side surfaces 230 that extend between and connect front surface 226. Main body 224 further includes a rear surface 228 that opposes front surface 226 and a bottom surface 232 that opposes lid 225 and/or upper surface 212. Wheel(s) 217 are coupled to main body 224 along side surface(s) 230 and extend past (behind in orientation shown in FIG. 5) rear surface 228.

Rolling utility module 210 includes a handles 234 coupled to main body 224. Handle 234 is retractable into main body 224 and FIG. 5 shows handle 234 in the retracted position. In various embodiments, one or more locks 236 are positioned on side surface 230 and lid 225 to secure lid 225 in a closed position against main body 224. In various embodiments, main body includes one or more stands 238 extending outward from rear surface 228. As will be discussed in greater detail below, the one or more stands 238 allow for positioning the rolling utility module 210 in an upright or vertical position (i.e., rear surface 228 in a generally horizontal orientation above ground surface).

Referring to FIG. 6, details of a rolling utility module 310 are shown according another exemplary embodiment. Rolling utility module 310 is substantially the same as rolling utility modules 10, 210 except for the differences discussed herein. In various embodiments, main body 324 of rolling utility module 310 includes an actuator 336 on side surface 330. When lid 325 is closed and secure to main body 324, actuator 336 can be used to open lid 325.

Rolling utility module 310 includes a first pair of wheels 317 positioned along opposing side surfaces 330 and adjacent to rear surface 328 and a second pair of wheels 338 extending from bottom surface 332 and adjacent to front surface 326. In specific embodiments, the second pair of wheels 338 are caster wheels. In various embodiments, the first pair of wheels 317 have a first dimension and the second pair of wheels 338 have a second dimension. In specific embodiments, the first dimension is different than the second dimension. In specific embodiments, the first dimension is greater than the second dimension. A handle 334 extends upward and away from upper surface 312 of rolling utility module 310. In specific embodiments, handle 334 extends in a generally vertical orientation (e.g., is generally perpendicular to main body 324).

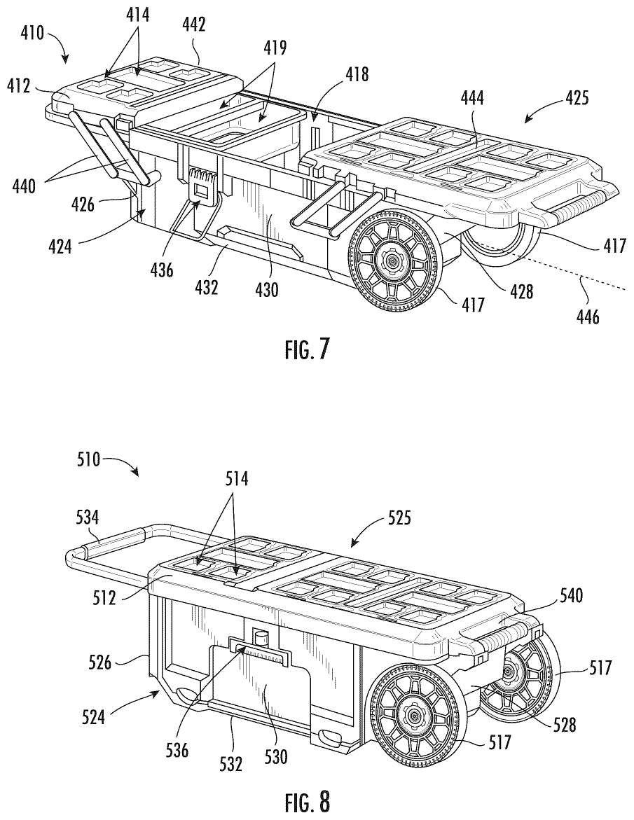

Referring to FIG. 7, details of a rolling utility module 410 are shown according another exemplary embodiment. Rolling utility module 410 is substantially the same as rolling utility modules 10, 210, 310 except for the differences discussed herein. Main body 424 defines a cavity 418. One or more trays 419 are positionable within cavity 418 underneath a lid 425.

The lid 425 includes a first section 442 and a second section 444. In other words, lid 425 is a split lid with more than one separate piece. In specific embodiments, first portion 442 of lid 425 has a first dimension and second portion 444 of lid 425 has a second dimension. In various embodiments, the first dimension is different than the second dimension. In specific embodiments, the first dimension of first portion 442 is less than the second dimension of the second portion 444 of lid 425. One or more hinges 440 connect first portion 442 of lid 425 and second portion 444 of lid 425 to main body 424. As will be generally understood, hinges 440 allow for moving first potion 442 and second portion 444 of lid along a major axis 446 of main body 424 rather than pivoting open.

When first portion 442 and second portion 444 of lid 425 are opened, first portion 442 moves in a first direction toward front surface 426 and second portion 444 moves in a second direction toward rear surface 428. When first portion 442 of lid 425 is an in open position, at least a portion of first portion 442 of lid 425 extends past or beyond front surface 426. When second portion 444 of lid 425 is an in open position, at least a portion of first portion 444 of lid 425 extends past or beyond rear surface 428. In various embodiments, main body 424 of rolling utility module 410 includes a lock 436 on side surface 430 that can be actuated to engage lid 425 and second lid 425 in place relative to main body 424. In various embodiments, lock 436 can be used to engage at least one or first portion 442 and second portion 444 of lid 425.

Referring to FIG. 8, details of a rolling utility module 510 are shown according another exemplary embodiment. Rolling utility module 510 is substantially the same as rolling utility modules 210, except for the differences discussed herein.

A lid 525 coupled to main body 524 includes a handle 540 extending outward and away from main body 524. In specific embodiments, handle 540 extends outward and in a direction away from rear surface 528 of rolling utility module 510. A second handle, shown as a retractable handle 534 extends outward and away from front surface 526 when handle 534 is in the extended or non-retracted position.

In various embodiments, main body 524 of rolling utility module 510 includes an actuator 536 on side surface 530. When lid 525 is closed and secure to main body 524, actuator 536 can be used to open lid 525.

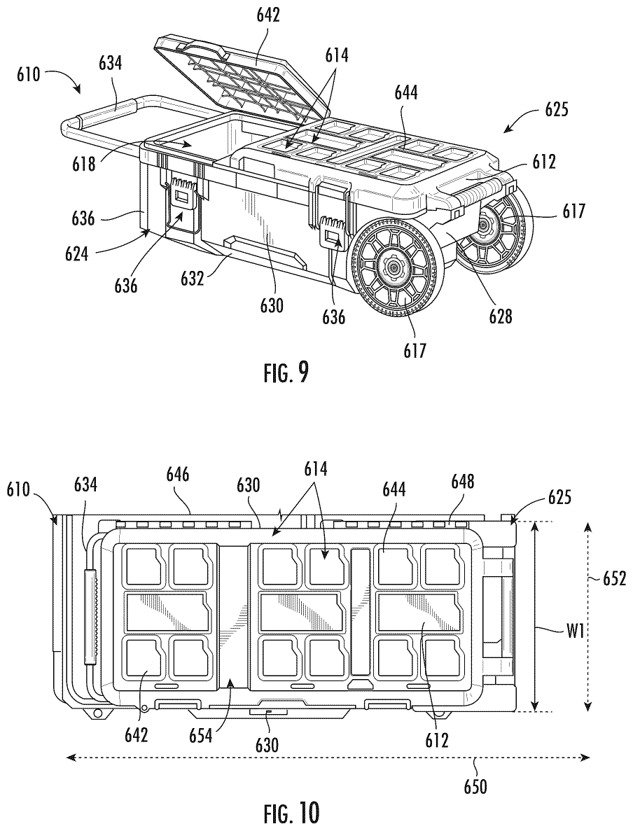

Referring to FIGS. 9-11, details of a rolling utility module 610 are shown according another exemplary embodiment. Mobile or rolling utility module 610 is substantially the same as rolling utility modules 10, 210, 310, 410, 510 except for the differences discussed herein. Female couplers 614 are substantially the same as female couplers 14.

Rolling utility module 610 includes a split lid 625 having a first section 642 and a second section 644 that are separately openable. In specific embodiments, a first hinge 646 is positioned along a side surface 630. First hinge 646 is coupled to first section 642 of lid 625 such that first section 642 is pivotally coupled to main body 624. In specific embodiments, a second hinge 648 is positioned along side surface 630 and spaced from first hinge 646. Second hinge 648 is coupled to second section 644 of lid 625 such that second section 644 is pivotally coupled to main body 624. As will be generally understood, the split lid 625 allows access to the storage cavity 618 of the rolling utility module 610 even when other modular storage units are stacked on the other section 642, 644 of the lid 625. For example, the split lid 625 allows the smaller first lid portion 642 to open while other storage units remain stacked and coupled to the female coupling components 614 of the larger lid portion 644.

As shown in FIG. 10, lid 625 and upper surface 612 include a plurality of female couplers 614. In various embodiments, first section 642 of lid 625 and second section 644 of lid 625 each include a plurality of female couplers 614. Main body 624 and/or rolling utility module 610 includes a major axis 650 that extends in a parallel orientation to side surface 630. Major axis 650 is perpendicular to minor or transverse axis 652. Minor axis 652 extends in a parallel orientation to front surface 626 and rear surface 628. In specific embodiments, major axis 650 extends in a length direction of main body 624 and/or rolling utility module 610. In specific embodiments, minor axis 652 extends in a width direction of main body 624 and/or rolling utility module 610.

As previously discussed, in various embodiments, the female couplers 614 define a sliding direction in which additional units or modules will slide to engage the array of female couplers 614. In other words, the sliding direction is a direction of engagement for coupling utility module(s) to rolling utility module 610. In specific embodiments, this sliding direction is perpendicular to the side surface 630 of the rolling utility module 610. In specific embodiments this sliding direction is parallel to the axle of the wheels 617 of the rolling utility module 610. In specific embodiments, the sliding direction is parallel to the minor axis 652 of main body 624 and/or rolling utility module 610. In other words, the sliding direction for attaching addition units or modules to lid 625 of rolling utility module 610 is from the side. In one or more specific embodiments, recessed section 654 extends in a direction that is parallel to the minor axis 652 of main body 624. In various embodiments, recessed section 654 is offset or spaced from a central transverse axis. In other words, recessed section 654 is not centrally located on lid 625. In one or more specific embodiments, lid 625 is not symmetrical. In such embodiments, a different number of female couplers 614 are positioned on opposing sides of recessed section 654.

In specific embodiments, the rolling utility module 610 includes a large array of female couplers 614 at the end of the lid 625 adjacent to the wheels 617, and a small array of female couplers 614 at the end of the lid 625 closer or adjacent to the handle 634. A large array of female couplers 614 has a greater number of female couplers 614 than a small array of female couplers 614. In specific embodiments, the small array of female couplers 614 includes a 2×2 arrangement of female couplers 614. In specific embodiments, a large array of female couplers 614 includes a 4×2 arrangement of female couplers 614. In other words, in such specific embodiments a large array of female couplers 614 includes rows of four female couplers 614 and columns of two female couplers 614. In various specific embodiments, a number of female couplers 614 on second section 644 of lid 625 is 2 times a number of female couplers 614 on first section 642 of lid 625.

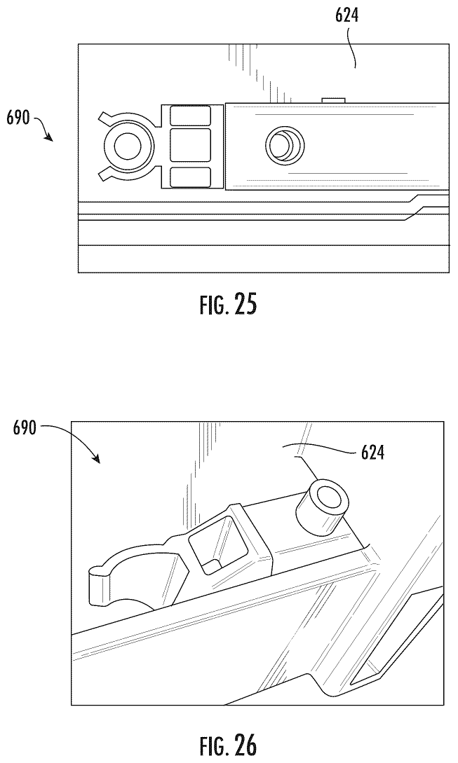

In various embodiments, first section 642 of lid 625 includes a small array of female couplers 614. In other words, in such specific embodiments, first section 642 of lid 625 includes female couplers 614 in a 2×2 arrangement. In various embodiments, second section 644 of lid 625 includes a large array of female couplers 614. In other words, in such specific embodiments, second section 644 of lid 625 includes female couplers 614 in a 4×2 arrangement. As will be discussed in greater detail below, lid 625 includes a recessed section 654 that defines a gap or space between female couplers 614 of first section 642 of lid 625 and second section 644 of lid 625. Recessed section 654 extends between a first side edge of the lid 625 and an opposing side edge of the lid 625. First side edge and second side edge of lid 625 extend along the respective side surfaces 630 of main body. In specific embodiments, the rolling utility module 610 includes a handle locking mechanism (see e.g., FIGS. 25-26) to lock the handle 634 in the extended position.

In various embodiments, a length, L1, of main body 624 is defined between front surface 626 and rear surface 628 of main body 624. In specific embodiments, the length is less than 990 mm. In specific embodiments, the length is about 897 mm (e.g., 897 mm plus or minus 90 mm). In various embodiments, a width, W1 of main body 624 is defined between opposing side surfaces 630. In specific embodiments, the width is less than 21 inches. In specific embodiments, the width is about 15.9 inches (e.g., 15.9 inches plus or minus 2 inches). In various embodiments, a depth, D1 is defined between an uppermost surface of main body 624 and bottom surface 632. In various embodiments, the depth is about 247 mm (e.g., 247 mm plus or minus 25 mm).

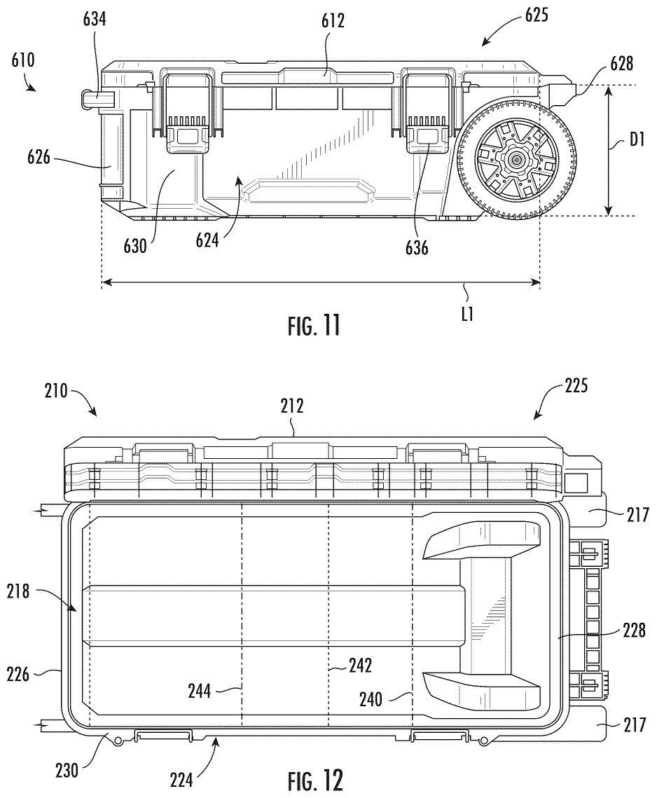

Referring to FIGS. 12-15, details of cavity 218 of rolling utility module 210 are shown, according to an exemplary embodiment. As will generally be understood, although the outer dimensions of rolling utility module 210 are compact, the size of cavity 218 allows for storage of a variety of objects and/or tools and for division of cavity 218 into smaller sections.

For example, as shown in FIG. 12, a divider 240 can be positioned about ⅔ of the total length to create a large storage compartment away from the well for wheels 217. Alternatively, a divider 242 can be positioned at about half the total length to create two separate compartments. In some embodiments, a divider 244 can be positioned at about a ⅓ of the total length (away from front surface 226) to create two separate compartments.

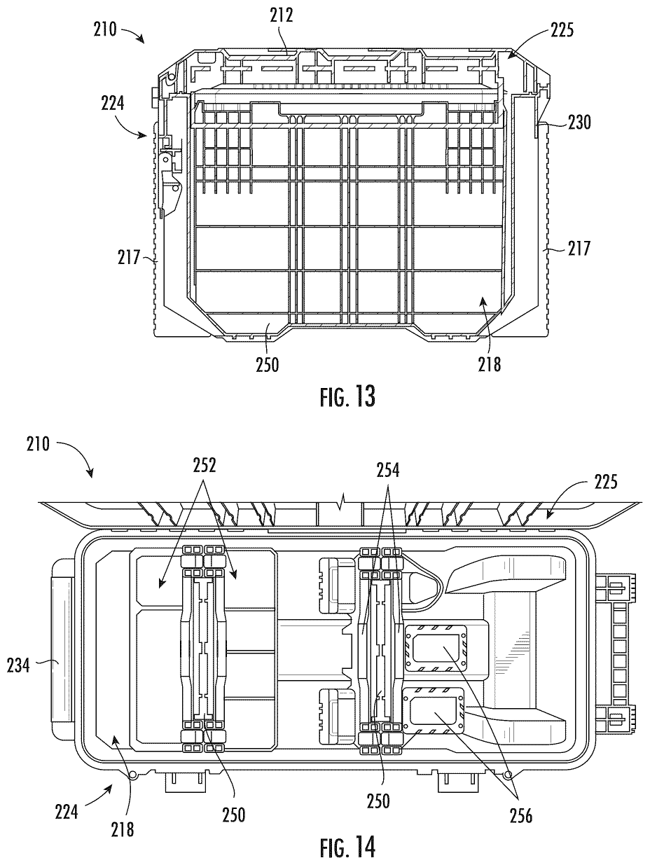

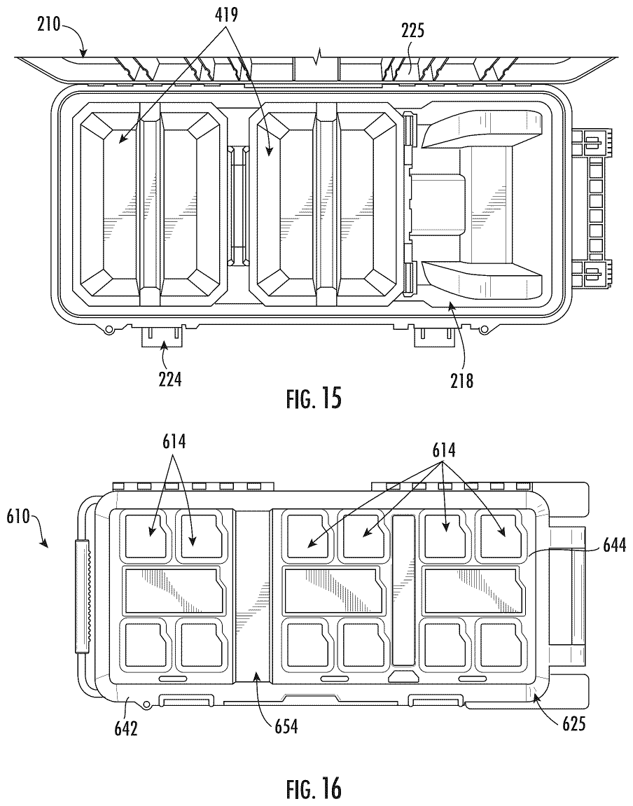

As shown in FIG. 13, a divider 250 includes coupling features configured to mate and engage with features on the inner side surfaces and bottom surface of cavity 218 as well as a bottom of lid 225. Applicant believes this allows divider 250 to act as a shelf when rolling utility module 210 is in an upright (or vertical) position. As shown in FIGS. 14-15, dividers 250 can be coupled within cavity 218 and used to support various rails 254 and/or trays 252. For example, rails 254 are configured to support energy storage devices, shown as batteries 256. Further, main body 224 can also support trays 419 within storage cavity 218.

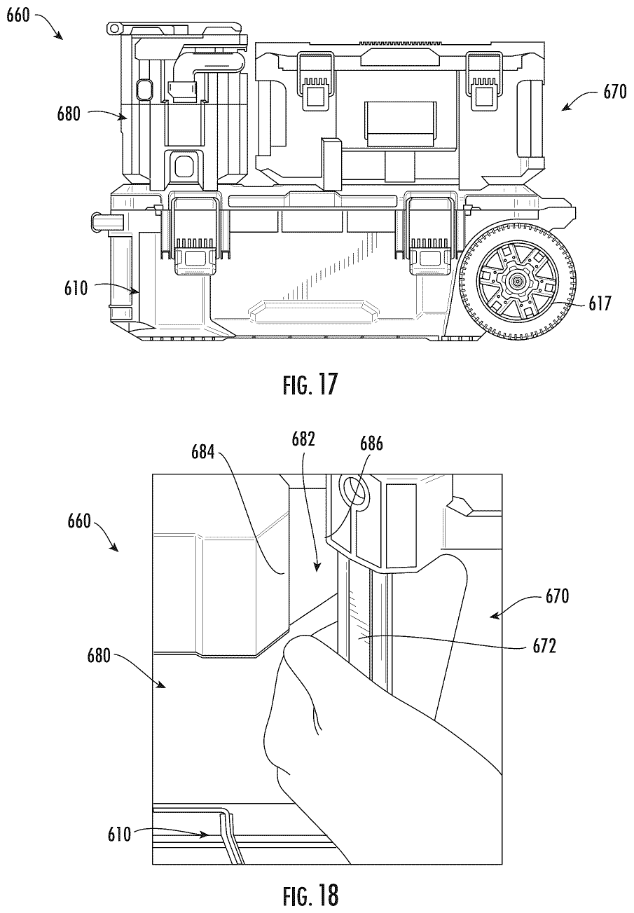

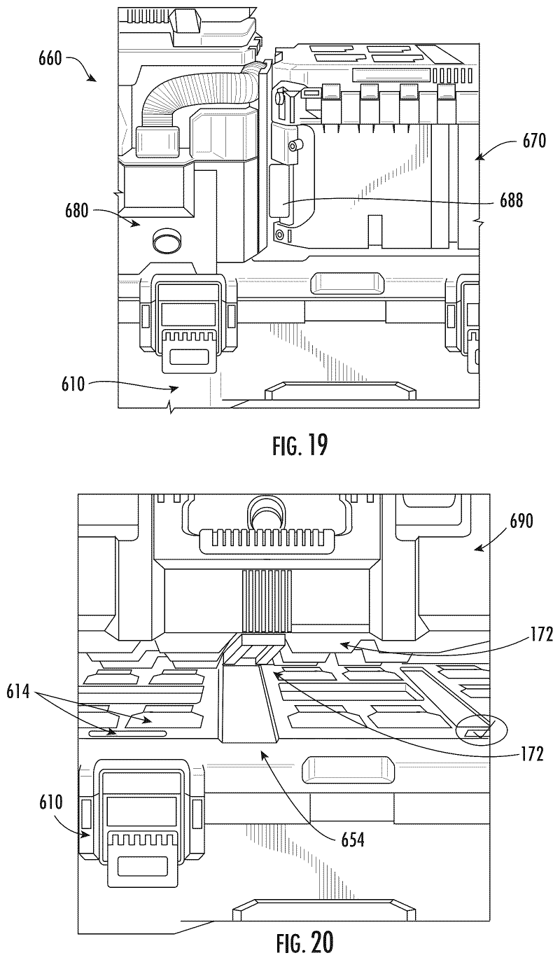

Referring to FIGS. 16-20, details of recessed section 654 of lid 625 and the assembly of a modular storage system 660 are shown according to an exemplary embodiment. Rolling utility module 610 and/or the previously described rolling utility modules 210, 310, 410, 510 can be utilized with modular storage system 660.

As previously discussed, in various embodiments, one of the first 642 and second sections 644 of the lid 525 includes a recessed space 654 between the female couplers 614 on each portion of the lid 625 such that positioning and/or locking another storage unit to the split lid 625 in a position the prevents opening the first 642 or second section 644 of the lid 625 is prevented. Modular storage system 660 includes rolling utility module 610 coupled to a utility module 680 that includes a small array of male coupler (see e.g., 172 in FIG. 4) and a utility module 670 that includes a full array of male couplers.

Furthermore, as shown in FIG. 18, the recessed space 654 is sized such that rolling utility module 610 remains, compact however, still large enough that a user can fit around an extrusion 672 of utility module 670. Additionally, the recessed space 654 provides enough space such that a mounting rail 618 can be coupled to the side of utility module 670 facing utility module 680. In other words, recessed space 654 provides enough space between adjacent utility module 670 and utility module 680 such that both are coupled to rolling utility module 610 without requiring disassembly of accessories such as rails 618. In various embodiments, recessed space 654 is the recessed section is sized such that a utility module is unable to engage both the female couplers 614 of the first section 642 and the female couplers 614 of the second section 644.

Referring to FIG. 20, further details of recessed space 654 are shown. When a user attempts to couple a utility module 670 having a full array of male couplers 172 across space 654 and first portion 642 and second portion 644 of lid 625, recessed space 654 prevents utility module 670 from fitting or coupling to lid 625. In other words, a utility module such as utility module 670 that has a full array of male coupler 172 (e.g., 4×2) will only coupled to rolling utility module 610 on second portion 644 of lid 625 that has a full array of female coupler 614. In this manner, incorrect coupling across split lid 625 is prevented.

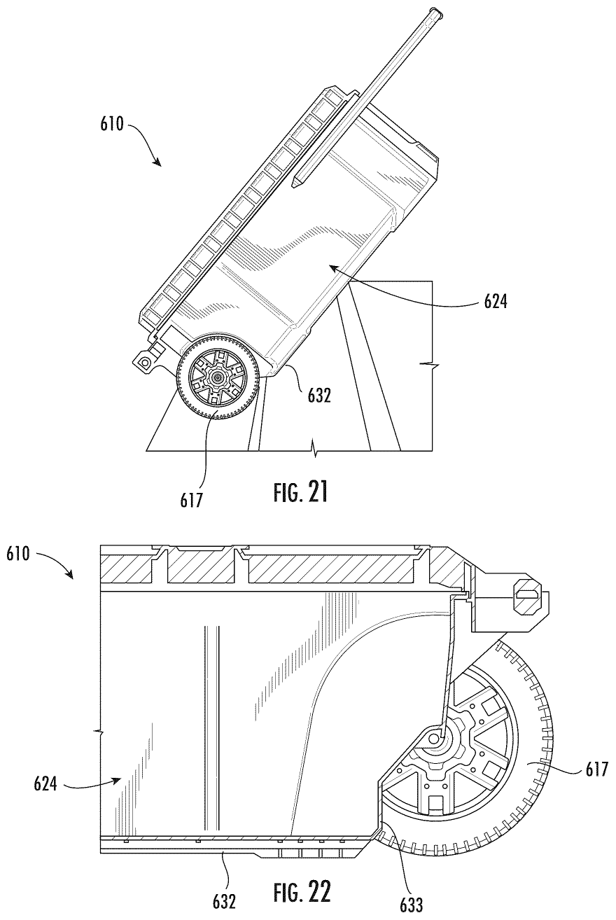

Referring to FIGS. 21-22, details of bottom surface 632 and a rear edge 633 of rolling utility module 610 are shown according to an exemplary embodiment. As will be generally understood, moving rolling modules such as rolling utility module 690 up stairs can be difficult due to the bottom surface 632 or rear edge 633 getting caught or restrained by the vertical portion of a step. In contrast to conventional utility modules, rolling utility module 610 has a rear edge 633 shaped to reduce the likelihood of unwanted engagement with stairs. Furthermore, the lowermost point of bottom surface 632 is aligned with the lowermost point of wheel 617.

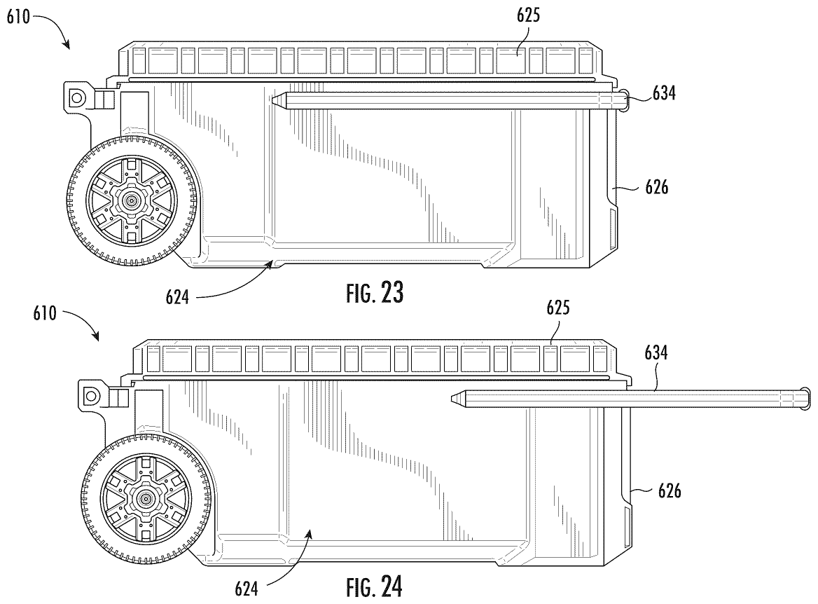

Referring to FIGS. 23-24, details of retractable handle 634 that can be utilized with various utility modules discussed herein are shown. FIG. 23 shows retractable handle 634 in a retracted position and adjacent to front surface 626 of rolling utility module 610. FIG. 24 shows retractable handle 634 in an extended position. When handle 634 is in the extended positioned, a distance between handle 634 and front surface 626 is greater than a distance between handle 634 and front surface 626 when handle 634 is in the retracted position (see e.g., FIG. 23). Retractable handle 634 is configured to allow for reliable push and/or pull of rolling utility module 610.

Referring to FIGS. 25-26, details of a handle locking mechanism 690 are shown according to an exemplary embodiment. Handle locking mechanism 690 couples to retractable handle 634 and secures retractable handle 634 in the extended position. In various specific embodiments, retractable handle 634 includes an actuator to lock or secure handle 634 in the retracted and/or extended position.

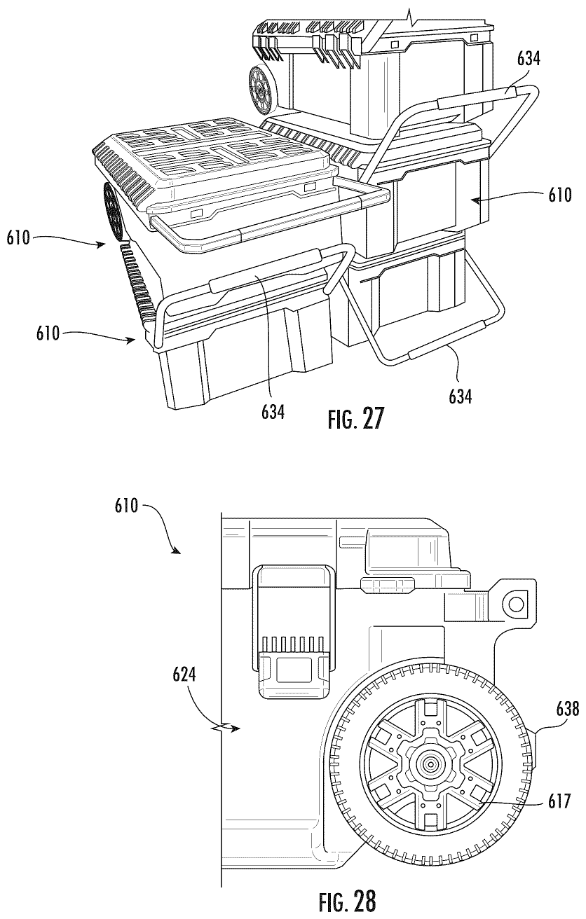

Referring to FIG. 27, further details of retractable handle 634 are shown. In specific embodiments, retractable handle is formed from a metal such as 1080 steel. Applicant believes such a handle material increases durability of retractable handle 634 and reducing likelihood of unwanted bending of handle 634.

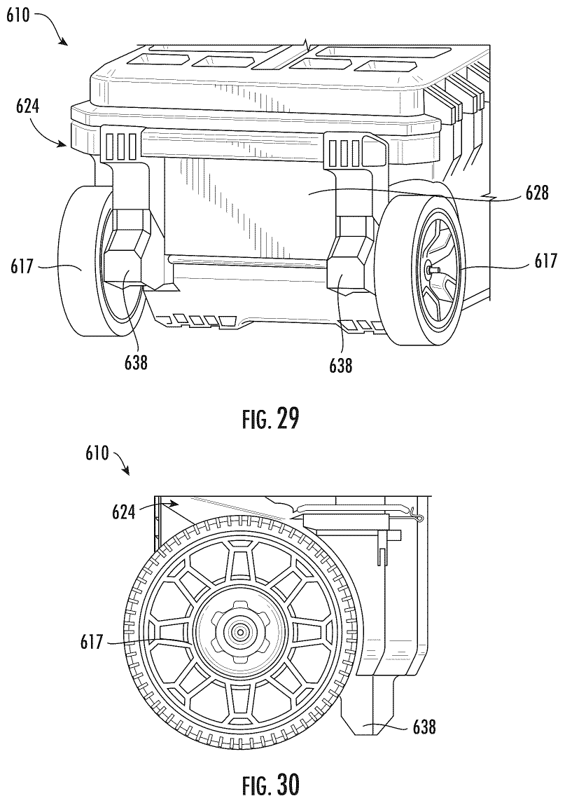

Referring to FIGS. 28-30, details of one or more stands 638 for rolling utility module 610 are shown, according to an exemplary embodiment. In various embodiments, main body 624 includes one or more stands 638 extending outward from rear surface 628. The one or more stands 638 allow for positioning the rolling utility module 610 in an upright or vertical position (see e.g., FIG. 30) while maintaining stability of module 610. In specific embodiments, rolling utility module 610 includes a pair of stands 638, with each one of the stands 638 positioned adjacent to a wheel 617.

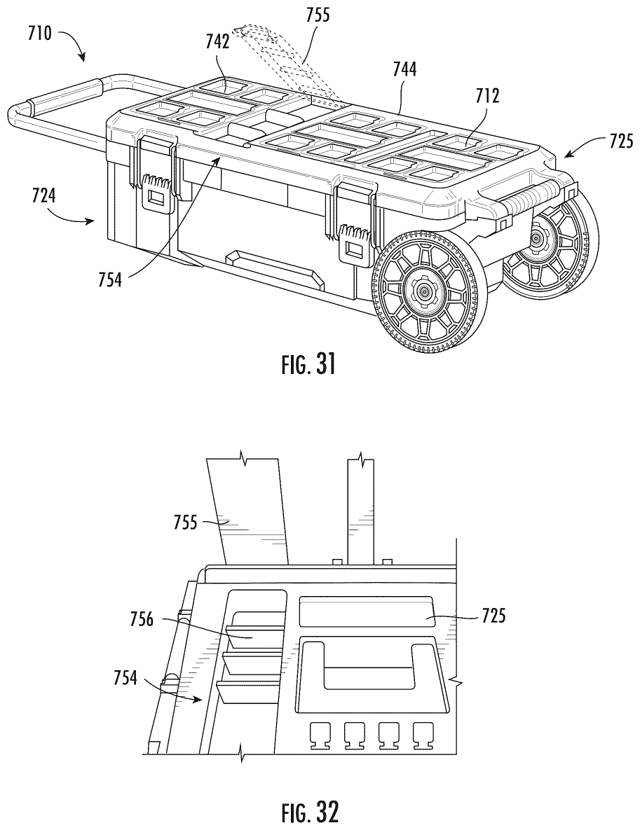

Referring to FIGS. 31-32, details of a lid storage compartment 754 for a rolling utility module 710 are shown according to an exemplary embodiment. Rolling utility module 710 is substantially the same as rolling utility modules 10, 210, 310, 410, 510, 610 except for the differences discussed herein.

In specific embodiments, lid storage compartment 754 is positioned between a first portion 742 and a second portion 744 of lid 725. In such embodiments first portion 742 of lid 725 includes a small array of female couplers 714 and second portion 744 of lid 725 includes a large array of female couplers 714. A compartment lid 755 is pivotally coupled to storage compartment 754. In specific embodiments, one or more dividers 756 are positioned within lid storage compartment 754.

In specific embodiments, lid storage compartment 754 is sized to prevent unwanted coupling of utility modules across first portion 742 and second portion 744 of lid 725. Lid storage compartment 754 is substantially the same as recess 654 except for the addition of easily accessible storage space within lid 725.

Lid storage compartment 754 prevents utility module(s) of inappropriate size from fitting or coupling to lid 725. In other words, a utility module such as utility module 690 that has a full array of male coupler 172 (e.g., 4×2) will only couple to rolling utility module 710 on second portion 744 of lid 725 that has a full array of female coupler 714. In this manner, incorrect coupling across lid 725 is prevented.

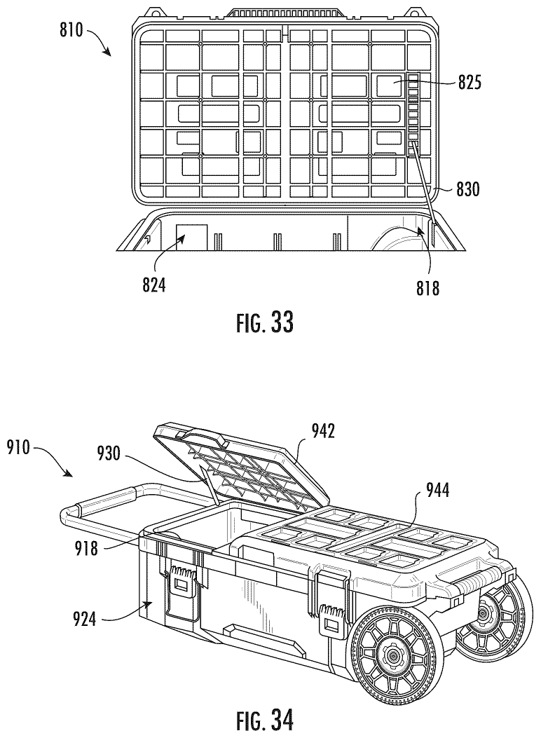

Referring to FIGS. 33-34, details of lid props that can be utilized with rolling utility modules are shown according to exemplary embodiments. Rolling utility modules 810 and 910 are substantially the same as rolling utility modules 10, 210, 310, 410, 510, 610, 710 except for the differences discussed herein.

Rolling utility module 810 has a single lid 825 and a prop 830 that extends between and connects to lid 825 and main body 824. Lid prop 830 maintains lid 825 in an open or pivoted position. Referring to FIG. 34, details of a split lid 925 of rolling utility module 910 are shown. In a specific embodiment, a lid prop 930 is coupled to and extends between first potion 942 of lid 925 and main body 924. In a specific embodiment a second lid prop is coupled to and extends between second portion 944 of lid 925 and main body 924. In various embodiments, rolling utility module 910 includes more than one lid prop 930 with a lid prop for each portion 942, 944 of lid 925.

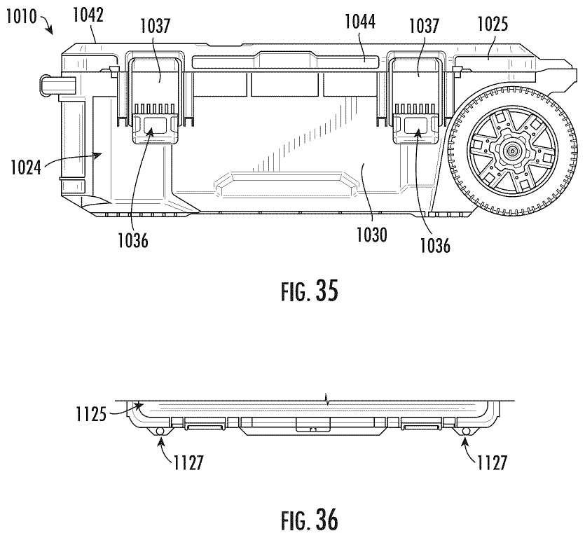

Referring to FIG. 35, details of a rolling utility module 1010 are shown according to another exemplary embodiment. Rolling utility module 1010 is substantially the same as rolling utility modules 10, 210, 310, 410, 510, 610, 710, 810, 910 except for the differences discussed herein. Main body 1024 includes one or more labels and/or indica 1037 along side surface 1030. In specific embodiments, the one or more labels 1037 are positioned between a lock 1036 and lid 1025. In specific embodiments, lid 1025 is a split lid with a first portion 1042 and a second portion 1044. In such embodiments, a label 1037 is positioned between lock 1036 and first portion 1042 and second portion 1044 of lid 1025 respectively.

Referring to FIG. 36, details of a lid 1125 for a rolling utility module are shown according to another exemplary embodiment. Lid 1125 includes one or more bores 1127 sized to receive a lock, such as a padlock. A user can attach a padlock through bore 1127 to secure and lock a rolling utility module.

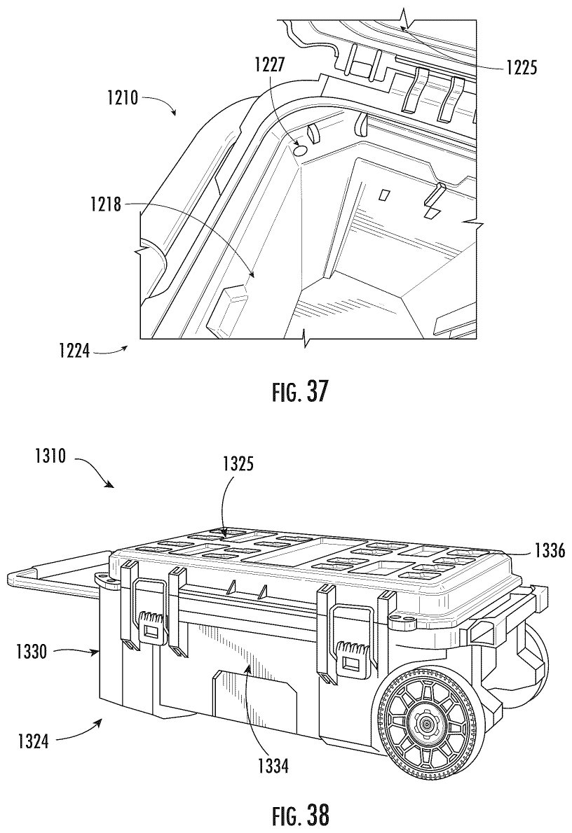

Referring to FIG. 37, details of a rolling utility module 1210 are shown according to another exemplary embodiment. Rolling utility module 1210 is substantially the same as rolling utility modules 10, 210, 310, 410, 510, 610, 710, 810, 910 except for the differences discussed herein. Main body 1224 and more specifically cavity 1218 includes a vacuum release hole 1227.

Referring to FIGS. 38-39, details of a rolling utility module 1310 are shown according to another exemplary embodiment. Rolling utility module 1310 is substantially the same as rolling utility modules 10, 210, 310, 410, 510, 610, 710, 810, 910, 1010, 1110, 1210 except for the differences discussed herein. Main body 1324 and includes one or more corners 1330. As shown in FIG. 39, the one or more corners 1330 includes recessed sections or core outs 1332. In various embodiments, the lid 1325 of rolling utility module 1310 will include an IML 1336. In such embodiments, the IML occupies the center pair of female couplers (see e.g., 14).

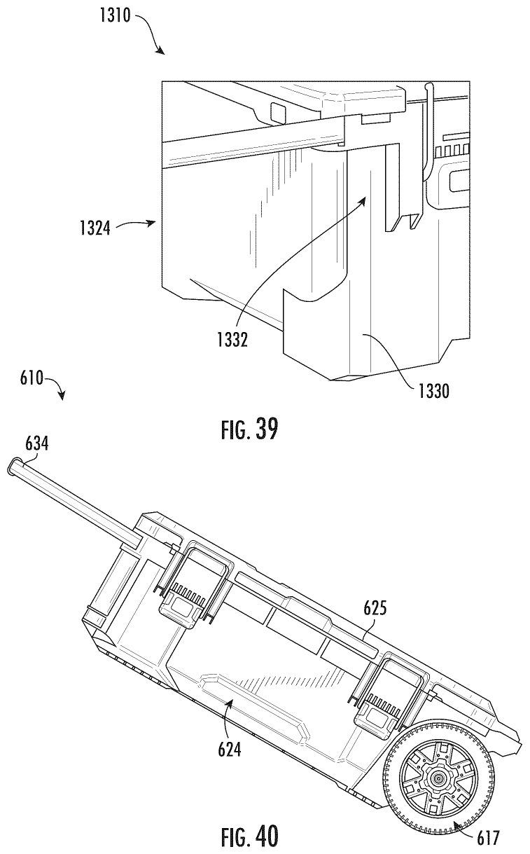

Referring to FIG. 40, relative dimensions of rolling utility module 610 are shown according to an exemplary embodiment. Applicant believes the dimensions of rolling utility module 610 reduce the likelihood that a user accidentally kicks main body 624 as they are walking with and/or pulling rolling utility module 610.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A mobile utility module comprising:
a main body comprising:
a front surface;
a rear surface opposing the front surface; and
a pair of side surfaces, each of the pair of side surfaces extending along a major axis of the main body and connecting the front surface and the rear surface;
a pair of wheels, each one of the pair of wheels positioned along a respective one the pair of side surfaces;
an extendable handle extending from the front surface; and
a lid comprising:
a first portion pivotably coupled to the main body, the first portion comprising:
a first upper surface; and
a first plurality of female couplers positioned on the first upper surface and arranged in a small array; and
a second portion pivotably coupled to the main body, the second portion comprising:
a second upper surface; and
a second plurality of female couplers positioned on the second upper surface and arranged in a large array;
wherein a number of the second plurality of female couplers is 2 times a number of the first plurality of female couplers;
wherein the first portion of the lid is independently pivotable from the second portion of the lid;
wherein the first portion of the lid is positioned between the second portion of the lid and the extendable handle.

2. The mobile utility module of claim 1, wherein the large array of the second plurality of female couplers comprises a first row of 4 female couplers and a second row of 4 female couplers.

3. The mobile utility module of claim 2, wherein the first row and the second row each extend along the major axis of the main body.

4. The mobile utility module of claim 1, wherein the small array of the first plurality of female couplers comprises a first row of 2 female couplers and a second row of 2 female couplers.

5. The mobile utility module of claim 1, further comprising a recessed section defined in the first portion of the lid or the second portion of the lid, the recessed section extending between a first edge of the lid and a second edge of the lid that opposes the first edge and defining a gap between the first plurality of female couplers and the second plurality of female couplers.

6. The mobile utility module of claim 5, where the recessed section is sized such that a utility module is unable to engage the first plurality of female couplers and the second plurality of female couplers.

7. The mobile utility module of claim 1, wherein each of the first plurality of female couplers and the second plurality of female couplers comprise:
a recessed surface;
a first rib; and
a second rib;
wherein the first rib and the second rib each extend over the recessed surface, and each of the first plurality of female couplers and the second plurality of female couplers are configured to engage with male couplers of a first utility module.

8. The mobile utility module of claim 7, wherein each of the first plurality of female couplers and the second plurality of female couplers further comprise:
a back wall;
a first sidewall;
a second sidewall opposite the first sidewall; and
a front wall opposite the back wall;
wherein the first rib extends from the back wall along a minor axis of the main body, and wherein the second rib extends from the back wall along the minor axis of the main body.

9. The mobile utility module of claim 1, a first hinge coupled to the first portion of the lid and a second hinge coupled to the second portion of the lid.

10. A mobile utility module comprising:
a main body comprising:
a front surface;
a rear surface opposing the front surface; and
a pair of side surfaces, each of the pair of side surfaces extending along a major axis of the main body and connecting the front surface and the rear surface;
a pair of wheels, each one of the pair of wheels positioned along a respective one of the pair of side surfaces; and
a lid comprising:
a first portion pivotably coupled to the main body, the first portion comprising:
a first upper surface; and
a first plurality of female couplers positioned on the first upper surface;
a second portion pivotably coupled to the main body, the second portion comprising:
a second upper surface; and
a second plurality of female couplers positioned on the second upper surface; and
a recessed section positioned on one of the first portion of the lid and the second portion of the lid, the recessed section positioned between the first plurality of female couplers and the second plurality of female couplers;
wherein the recessed section is offset from a central minor axis of the main body;
wherein the first portion of the lid is independently pivotable from the second portion of the lid; and
wherein the first portion of the lid is positioned between the second portion of the lid and the front surface of the main body.

11. The mobile utility module of claim 10, wherein the recessed section is positioned on the first portion of the lid.

12. The mobile utility module of claim 10, wherein the first plurality of female couplers are configured to slidably engage with male couplers of a first utility module to couple the first utility module to the mobile utility module, and wherein an engagement direction is perpendicular to the major axis of the main body.

13. The mobile utility module of claim 10, wherein the first plurality of female couplers are configured to engage a first utility module and the second plurality of female couplers are configured to engage a second utility module such that the lid supports the first utility module and second utility module.

14. The mobile utility module of claim 13, wherein, when the first utility module and the second utility module are engaged with the lid, the recessed section is positioned between the first utility module and the second utility module.

15. The mobile utility module of claim 10, wherein a number of the second plurality of female couplers is 2 times a number of the first plurality of female couplers.

16. A mobile utility module comprising:
a main body comprising:
a front surface;
a rear surface opposing the front surface;
a pair of side surfaces, each of the pair of side surfaces extending between and connecting the front surface and the rear surface; and
a first wheel;
a second wheel connected to the first wheel by an axle, wherein the first wheel and second wheel are positioned along a respective one the pair of side surfaces;
a lid comprising:
a first portion pivotably coupled to the main body, the first portion comprising:
a first upper surface; and
a first plurality of female couplers positioned on the first upper surface;
a second portion pivotably coupled to the main body, the second portion comprising:
a second upper surface; and
a second plurality of female couplers positioned on the second upper surface; and
a recessed section extending between a first edge of the lid and an opposing second edge of the lid, the recessed section positioned on one of the first portion of the lid and the second portion of the lid between the first plurality of female couplers and the second plurality of female couplers;
wherein the first plurality of female couplers and the second plurality of female couplers are configured to slidably engage a plurality of male couplers of a utility module, and wherein a sliding engagement direction is parallel to an orientation of the axle.

17. The mobile utility module of claim 16, wherein the first plurality of female couplers are arranged in a small array and wherein the second plurality of female couplers are arranged in a large array comprising 2 times the female couplers as the small array.

18. The mobile utility module of claim 17, wherein the small array of the first plurality of female couplers comprises a first row of 2 female couplers and a second row of 2 female couplers, and wherein the large array of the second plurality of female couplers comprises a first row of 4 female couplers and a second row of 4 female couplers.

19. The mobile utility module of claim 16, wherein each of the first plurality of female couplers comprises:
a recessed surface;
a back wall;
a first rib; and
a second rib;
wherein the first rib and the second rib each extend over the recessed surface, and wherein the first rib and the second rib each extend from the back wall in the sliding engagement direction.

20. The mobile utility module of claim 16, wherein the main body further comprises a central minor axis extending in a parallel orientation to the sliding direction, and wherein the recessed section is offset from the central minor axis.
